(19) United States
(12) Patent Application Publication
(10) Pub. No.: US 2009/0027330 A1
(43) Pub. Date: Jan. 29, 2009

(54) DEVICE FOR USING VIRTUAL MOUSE AND GAMING MACHINE

(75) Inventor: Eiji AIDA, Zama (JP)

Correspondence Address: GLOBAL IP COUNSELORS, LLP, 1233 20TH STREET, NW, SUITE 700, WASHINGTON, DC, 20036-2680, US

(73) Assignee: KONAMI GAMING, INCORPORATED, Las Vegas, NV (US)

(21) Appl. No.: 11/828,580

(22) Filed: Jul. 26, 2007

(51) Int. Cl. G09G 5/00

(52) U.S. Cl. 345/156

(57) ABSTRACT

A virtual mouse device is preferably installed in a gaming machine, and serving as an input device. An image sensor unit is laminated on a specific area on a screen of a display unit, and detects fingers or a palm of a player that move on or over the specific area. The virtual mouse controller unit monitors the fingers or palm, and causes a virtual mouse to follow the fingers or palm within the specific area. If the fingers or palm moves out of the specific area, the virtual mouse controller unit then returns the virtual mouse to a default location. An input unit monitors the motion of the virtual mouse, and causes the display unit to move a mouse pointer on the screen depending on the amount and direction of travel of the virtual mouse.

### BACKGROUND OF THE INVENTION

1. Field of the Invention

The present invention relates to a gaming machine, and in particular a gaming machine comprising an input device using a virtual mouse.

2. Background Information

Gaming machines installed in arcades and casinos are generally remodeled at frequent intervals in order to continuously attract many players. Remodeling of gaming machines often requires replacement of the mechanisms thereof, such as mechanical reels and push buttons serving as input devices, in their entirety. Accordingly, mechanical gaming machines are being replaced with video gaming machines having little mechanical portions in order to facilitate frequent remodeling and maintenance thereof. For example, mechanical reels are replaced with video reels displayed in graphic form on a screen of an electric display device. Push buttons separately assigned to types of bets and paylines, a spin button or lever, and the like, are replaced with virtual buttons displayed on a touch panel, which are assigned to various functions of the gaming machine by software. Remodeling of such a gaming machine generally requires only data updates, such as image data for use in the display on the screen and the touch panel, and data about the relationship between the virtual buttons displayed on the touch panel and the functions of the gaming machine.

In recent years, video gaming machines are increasing their versatility. This is changing the video gaming machines from specialized devices conducting video games with limited content to multi-function devices capable of providing various services, which are not limited in games, like personal computers. The increasing versatility requires input devices with easier operability and higher functionality such as mouses and keyboards, than known input devices such as push buttons and touch panels.

Especially in casinos and arcades, gaming machines are used by a number of players, and accordingly require a greater degree of ruggedization. However, it is difficult to sufficiently ruggedize input devices separate from bodies of gaming machines such as mouses and keyboards. Indeed, such input devices are required to withstand rough handling by players getting hooked on games, and severe environmental conditions, e.g., various drinks spilling thereon and various dirt and soils gummed thereon. Higher levels of security are also required to protect such input devices from theft. As a result, the adoption of such input devices may increase the need for frequent maintenance, and therefore prevent further reductions in the cost of upkeep for gaming machines.

“Virtual mouses” are expected to be able to resolve the above difficulties in using input devices on gaming machines. A virtual mouse device is a type of graphic user interface, which reproduces a virtual mouse, i.e., a graphic image of a mouse on a touch panel (e.g., U.S. Patent Application Publication No. 2006/0034042). The touch panel detects fingers and a palm of a user that touch an area of a screen in which the virtual mouse is reproduced. When the user slides his/her fingers and palm on the screen as if to operate a real mouse, the device causes the virtual mouse to follow the fingers and palm within the screen. Since a virtual mouse does not have a real body, the device resists damages caused by rough handling and dirt. In addition, the virtual mouse is never stolen.

A prior art virtual mouse device uses a touch panel that typically detects changes in structure or stress caused by press forces of user's fingers and palm touching a screen. As long as the fingers and palm touch the screen, the device can determine the location of a virtual mouse. If all the fingers and palm are lift from the screen, the device then keeps the virtual mouse at the last location for a predetermined time. If neither finger nor palm is detected again during the predetermined time in the area where the virtual mouse is reproduced, the device then returns the virtual mouse to a default location. The predetermined time has to be appropriately long in order to prevent the virtual mouse from an unintended return to the default location each time the touch panel fails to detect the fingers and palm. On the other hand, the device is required to allow operations of the virtual mouse to emulate operations of a real mouse, in particular, cyclical actions of a real mouse that a user slides from a location, lifts, and returns to the location in turn in order to cause a mouse pointer to travel a long distance across a screen. A manageable emulation of the cyclical actions requires the virtual mouse to be quickly returned to the default location once the fingers and palm have been lift from the screen. Accordingly, the device has to trade off the reduction of the unintended returns to the default location against the manageable emulation of the cyclical actions. This prevents operability of the virtual mouse from being further improved.

In view of the above, it will be apparent to those skilled in the art from this disclosure that there exists a need for an improved virtual mouse device, which can both reduce unintended returns of a virtual mouse to a default location, and cause the virtual mouse to respond more quickly. This invention addresses this need in the art as well as other needs, which will become apparent to those skilled in the art from this disclosure.

### SUMMARY OF THE INVENTION

A virtual mouse device according to the present invention comprises a display unit, an image sensor unit, a virtual mouse controller unit, and an input unit. The display unit displays one or more images on a screen. The images preferably include images providing a user with information, images for decoration and visual effects, and icons linked instructions or data to be entered into a host machine, which uses the virtual mouse device as an input device. The image sensor unit detects fingers or a palm of a user that move on or over a specific area on the screen. The image sensor unit preferably includes a matrix of pixels arranged in the specific area. Each pixel preferably includes a photodiode, a capacitor, and a switching transistor. In this case, the image sensor uses the photodiodes to capture light reflected from fingers or a palm of a user that move on or over the specific area and convert the light to an electric signal. More preferably, the display unit and the image sensor unit are integrated into a single panel. In this case, the image sensor unit and the display unit preferably include arrays of capacitors and transistors implemented in the same substrate. The virtual mouse controller unit monitors the fingers or palm of the user that move on or over the specific area by using the image sensor unit, and causes a virtual mouse to follow the fingers or the palm within the specific area by using the display unit. If the fingers or the palm moves out of the specific area, the virtual mouse controller unit then returns the virtual mouse to a default location in the specific area. The input unit monitors the motion of the virtual mouse, and causes the display unit to move a pointer or cursor image, i.e., a mouse pointer or cursor on the screen depending on the amount and direction of travel of the virtual mouse. The input unit preferably decodes an instruction or data from the relationship in location between the images and the mouse pointer or cursor on the screen.

The image sensor unit can detect the location of fingers and a palm of a user, even if the fingers and palm are separated from the surface of the screen. Accordingly, the virtual mouse controller unit can determine the location of the virtual mouse with a high degree of reliability when all the fingers and palm are lift from the screen temporally or accidentally. This allows the virtual mouse to respond to the action of the fingers and palm with a higher degree of stability than a prior art virtual mouse depending on detection of user's fingers or palm by using a touch panel.

If the fingers or palm moves out of the specific area, the virtual mouse controller unit then returns the virtual mouse to a default location. Here, the input unit keeps the mouse pointer or cursor at the last location. This allows a user to operate the virtual mouse in order to cause the mouse pointer or cursor to travel a long distance across the screen as follows. The user first moves his/her fingers or palm from the default location of the virtual mouse to the outside of the specific area in a desired direction. The virtual mouse then follows the fingers or palm from the default location, and returns to the default location when the fingers or palm moves out of the specific area. The user repeats the movement of his/her fingers or palm from the default location to the outside of the specific area. Thus, the virtual mouse device can allow the user to easily emulate cyclical actions of a real mouse that the user slides from a location, lifts, and returns to the location in turn. In particular, the virtual mouse can return to the default location more quickly than the prior art virtual mouse. Therefore, the virtual mouse device can improve operability of the virtual mouse.

The display unit preferably comprises two or more separate screens, and the specific area preferably is placed on one of the screens. In this case, the input unit preferably causes the display unit to move the mouse pointer or cursor on one or more of the screens.

The virtual mouse preferably includes a virtual button or a virtual wheel. In this case, the virtual mouse controller unit preferably detects specific movements of one or more fingers detected by the image sensor unit, and the input unit preferably decodes a click of the virtual button or a roll of the virtual wheel from the specific movements of the fingers. In addition, the virtual mouse controller unit preferably causes the display unit to position the virtual button below the forefinger of the user that moves on or over the specific area. The virtual mouse controller can distinguish the forefinger from other fingers easily regardless of whether the user uses the virtual mouse with his/her right or left hand, since the image sensor unit can detect the whole shape of the user's hand. This improves the operability of the virtual mouse.

The virtual mouse controller unit preferably determines the size or shape of a hand from the fingers or palm of the user detected by the image sensor unit, and then adjusts the size or shape of the virtual mouse depending on the determined size or shape of the hand. In particular, the virtual mouse controller unit preferably distinguishes between the right and left hand of the user with which the user uses the virtual mouse, and then selects a right- or left-hand type of the virtual mouse. The virtual mouse controller unit preferably adjusts the size, shape, or location of the specific area on the screen depending on the determined size or shape of the hand.

The image sensor unit preferably detects fingers or a palm of a user that move on or over one or more optional areas on the screen. In this case, the virtual mouse controller unit preferably causes the display unit to initially display the optional areas on the screen. When the image sensor unit has detected fingers or a palm of a user within one of the optional areas, the virtual mouse controller unit preferably assigns the specific area to the optional area within which the image sensor unit has detected the fingers or palm of the user. This allows the user to select a desired optional area as the specific area. Furthermore, the virtual mouse controller unit preferably adjusts the shape of the virtual mouse depending on the location of the optional area to which the specific area has been assigned. For example, when there are optional areas on the right and left portion of the screen, most right handed users select the right portion, and vice versa. Accordingly, when the right or left portion has been assigned to the specific area, the virtual mouse controller unit may select a right- or left-hand type of the virtual mouse, respectively.

Alternatively, the virtual mouse controller unit may cause the display unit to initially display one or more options of virtual mouses on the screen. When the image sensor unit has detected fingers or a palm of a user within an area in which one of the options is displayed, the virtual mouse controller unit preferably assigns the virtual mouse to be actually used to the option that is displayed in the area within which the image sensor unit has detected the fingers or palm of the user. In addition, the virtual mouse controller unit preferably adjusts the location, size, or shape of the specific area depending on the initial location, size, or shape of the option which the virtual mouse to be actually used has been assigned.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a side view of a gaming machine according to an embodiment of the present invention;

FIG. 2 is a front view of the gaming machine shown in FIG. 1;

FIG. 3A is a plan view of a hand put on a mouse pad area in a screen of the gaming machine shown in FIG. 2;

FIG. 3B is a side view of the hand put on the mouse pad area shown in FIG. 3A;

FIG. 4 is a perspective view of a gaming machine according to another embodiment of the present invention;

FIG. 5 is a plan view of an input screen reproduced on a sub-display unit of the gaming machine shown in FIG. 4;

FIG. 6 is a block diagram of the gaming machine shown in FIG. 2;

FIG. 7 is a circuit diagram of an image sensor unit of the gaming machine shown in FIG. 2;

FIG. 8 is a circuit diagram of a sub-display unit of the gaming machine shown in FIG. 2;

FIG. 9A is a schematic view of a hand detected by the image sensor unit shown in FIG. 7;

FIG. 9B is a plan view of a virtual mouse reproduced on the mouse pad area of the gaming machine shown in FIG. 2;

FIGS. 10A, 10B, and 10C are schematic views of virtual mouses adjusted in size and shape by a virtual mouse controller unit shown in FIG. 6;

FIGS. 11A, 11B, 11C, and 11D are schematic views of specific actions of a finger detected by the image sensor unit shown in FIG. 7;

FIGS. 12A and 12B are plan views of the mouse pad area showing control over the virtual mouse of the virtual mouse controller unit shown in FIG. 6;

FIG. 13 is a flow chart of control over a virtual mouse of the virtual mouse controller unit shown in FIG. 6;

FIG. 14 is a flow chart of a function of an input unit shown in FIG. 6;

FIG. 15 is a schematic view of an invitational screen reproduced on the sub-display unit shown in FIG. 2; and

FIG. 16 is a schematic view of another invitational screen reproduced on the sub-display unit shown in FIG. 2.

### BEST MODE FOR CARRYING OUT THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

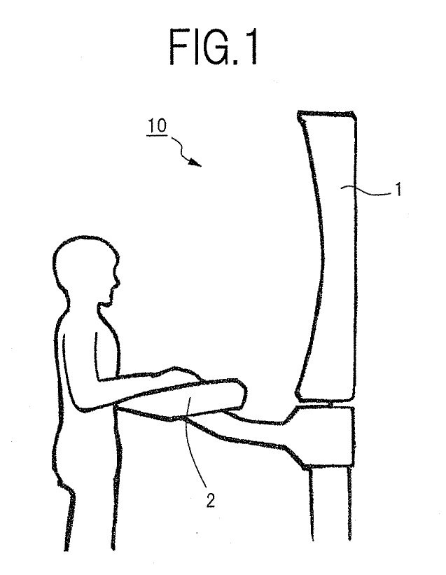

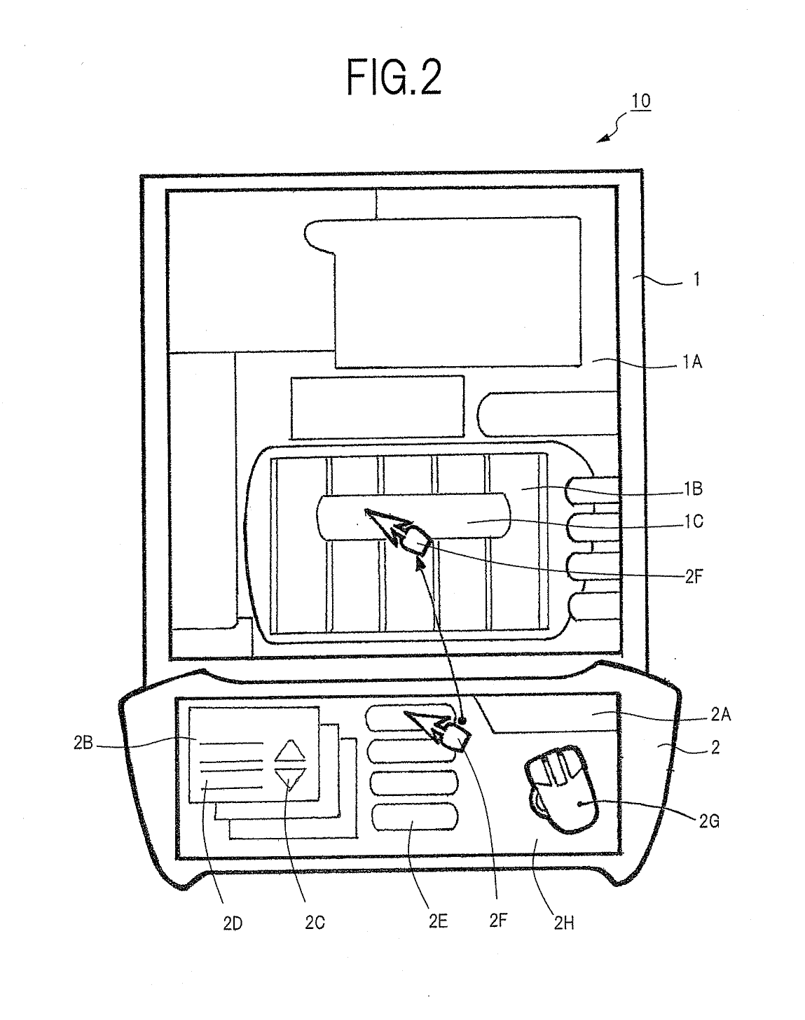

A virtual mouse device according to an embodiment of the present invention is preferably installed in a gaming machine located in a casino or an amusement arcade. Referring to FIGS. 1 and 2, the gaming machine 10 includes a main display unit 1 and a sub-display unit 2. The display units 1 and 2 preferably include a flat panel display, more preferably a liquid crystal display (LCD), or alternatively may include a plasma display or an organic light emitting device (OLED) display. Each display unit 1 or 2 preferably includes a single screen, or alternatively two or more separate screens.

Referring to FIG. 2, the main display unit 1 displays a game screen 1A, i.e., a screen on which various images represent the content of a game. When the gaming machine 10 conducts a slot game, for example, three or more video reels 1B are displayed on the game screen 1A. On each video reel 1B, a column of symbols is arranged and changed in type and order of symbols at random. This change is usually referred to as a spin of the video reel 1B. Note that the game screen 1A may include a mechanical moving portion. For example, the video reels 1B may be replaced with mechanical reels on which symbols are painted or displayed by using a flexible, electric display device such as flexible LCD, OLED, or electric paper. The game screen 1A may include additional images, for example, images for use in decoration and advertisements such as a logo of a game developer, images for use in visual effects in games, and visualized information about games such as pay tables, a guide to operations, the amount of a bet, the number of credits available, and a jackpot meter. The main display unit 1 preferably includes a large screen that is placed to be opposite to a player as shown in FIG. 1. The game screen 1A is preferably displayed on the large screen.

Referring to FIG. 2, the sub-display unit 2 is preferably placed at a player, and provides the player with a type of graphical user interface serving as a console panel. The sub-display unit 2 in particular displays an input screen 2A, i.e., a screen on which graphic elements such as windows 2B, icons 2C, menus 2D, and buttons 2E are displayed and linked to specific functions of the gaming machine 10 or specific data. By selecting a graphic element, a player can instruct the gaming machine 10 to perform a specific function, e.g., cue the video reels 1B for the start of a spin, or enter data, e.g., paylines to be selected or the amount of a bet to be placed into the gaming machine 10. The selection is preferably performed by using a mouse pointer (or cursor) 2F and a virtual mouse 2G, or additionally using a touch panel laminated on the input screen 2A, or mechanical keys and buttons mounted on the sub-display unit 2. The input screen 2A may include additional images, for example, images for use in decoration and advertisements such as a logo of a game developer, images for use in visual effects in games, and visualized information about games such as pay tables, a guide to operations, the amount of a bet, the number of credits available, and a jackpot meter.

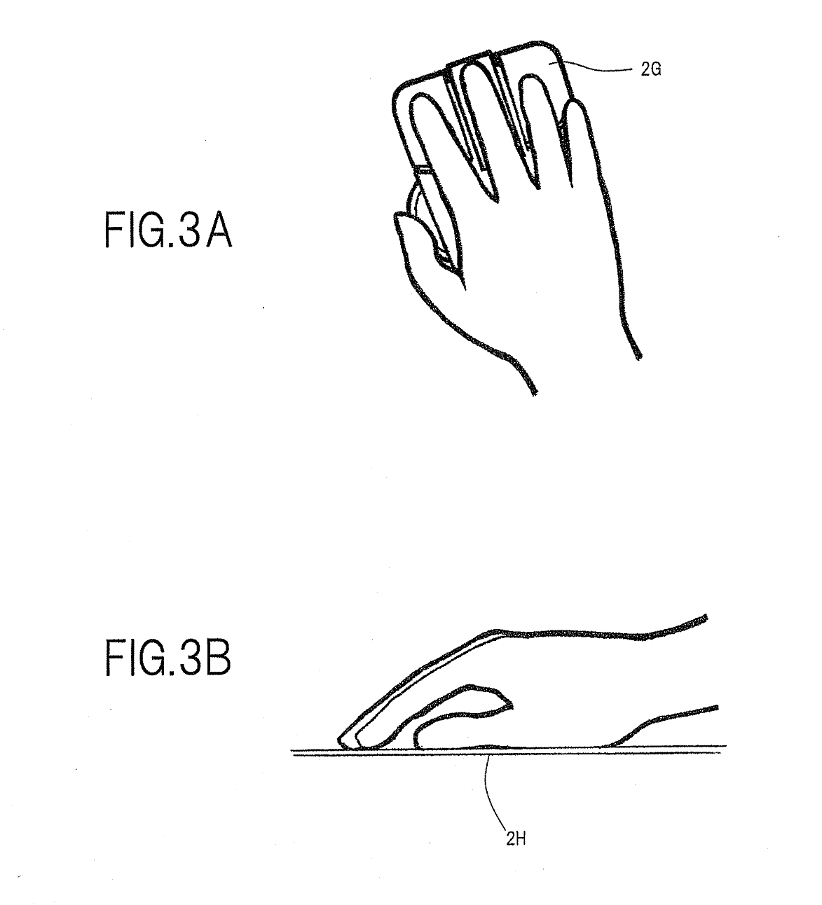

The mouse pointer 2F and the virtual mouse 2G are reproduced on the input screen 2A. The mouse pointer 2F can travel across the input screen 2A in response to actions of the virtual mouse 2G. More specifically, the amount and direction of the travel of the mouse pointer 2F are determined by those of the motion of the virtual mouse 2G. By placing the mouse pointer 2F at each graphic element, a player can select the graphic element. Here, some graphic elements 1C may be placed on the game screen 1A, and the mouse pointer 2F may jump into the game screen 1A as shown in FIG. 2. The virtual mouse 2G is a graphic image of a mouse reproduced on a specific area 2H of the input screen 2A, which is hereinafter referred to as a mouse pad area. An image sensor is laminated on the mouse pad area 2H. When a player places his/her hand on the virtual mouse 2G as shown in FIG. 3A, the image sensor preferably performs optical detection of fingers and a palm of the hand placed on the mouse pad area 2H as shown in FIG. 3B. When the player slides his/her fingers and palm on or over the mouse pad area 2H as if to operate a real mouse, the image sensor detects the movements of the fingers and palm. Based on the detected movements, the virtual mouse 2G is changed in its location to follow the fingers and palm. Preferably, the virtual mouse 2G includes a virtual button. When the player taps his/her forefinger on the virtual button, the movement of the forefinger is detected by the image sensor, and then interpreted as a click.

When the gaming machine 10 conducts a slot game, for example, a player first guesses on which payline a winning combination of symbols will appear, and then uses the virtual mouse 2G to place the mouse pointer 2F at buttons linked to a desired payline and a desired amount of a bet, and click the buttons. After that, the player again uses the virtual mouse 2G to place the mouse pointer 2F at a button linked to the function of spinning the video reels 1B, and click the button. Then, the video reels 1B start spinning, and will stop in turn after a predetermined time. If a winning combination appears on the payline on which the player has placed a bet, the player will win an amount of a payout that depends on the amount of the bet and the type of the winning combination.

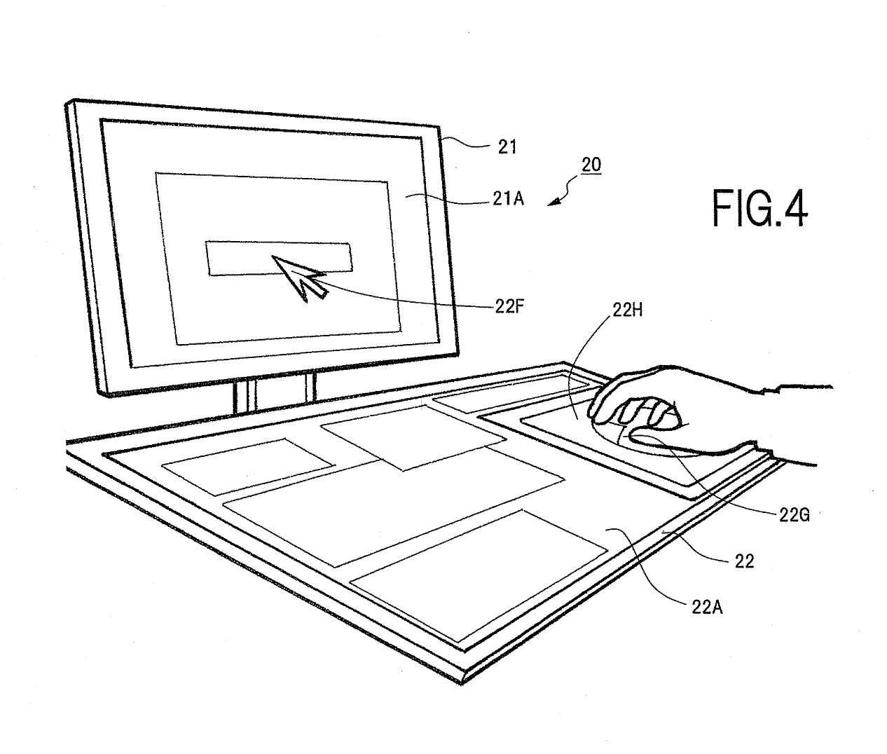

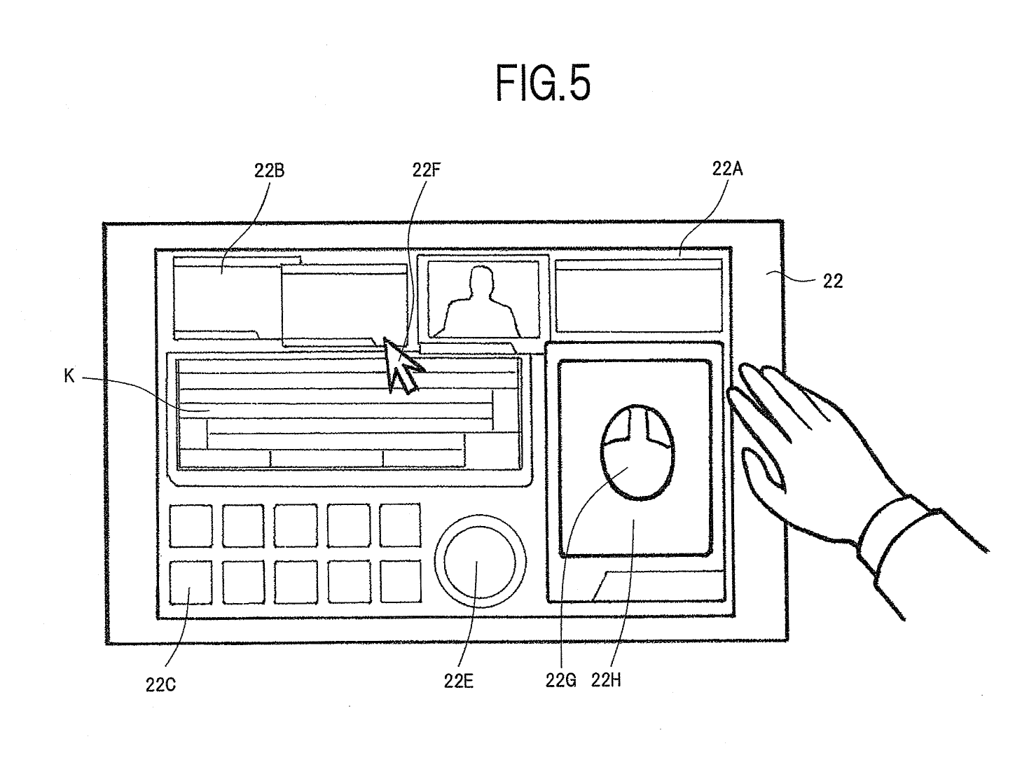

FIGS. 4 and 5 show another preferred embodiment of the present invention, which is a virtual mouse device installed in a video gaming machine 20, which is emulated in a desktop personal computer (PC), or alternatively may be emulated in a laptop PC. Note that the virtual mouse device can be used as a usual input device for PC. Like the gaming machine according to the first embodiment, the gaming machine 20 includes a main display unit 21 and a sub-display unit 22. The display units 21 and 22 preferably include a flat panel display, more preferably a LCD, or alternatively may include a plasma display or an OLED display. Each display unit 21 or 22 preferably includes a single screen, or alternatively two or more separate screens.

Referring to FIG. 4, the main display unit 21 is preferably placed to be opposite to a player, and displays a game screen 21A. On the other hand, the sub-display unit 2 is preferably placed at a player, and displays an input screen 22A serving as a console panel. Referring to FIG. 5, the input screen 22A includes a keyboard image 22K reproduced on a touch panel or an image sensor, in addition to graphic elements such as windows 22B, icons 22C, menus 22D, buttons 22E, a mouse pointer 22F, and a virtual mouse 22G. The touch panel or image sensor detects locations at which player's fingers touch the input screen 22A. From the relationship between the detected locations and the key arrangement on the keyboard image 22K, the gaming machine 20 interprets characters and numerals that the player has entered. In the input screen 22A, a mouse pad area 22H are clearly defined in contrast to the input screen 2A shown in FIG. 2. Preferably, the mouse pointer 22F can travel across both the input screen 22A and the game screen 21A as shown in FIGS. 4 and 5. Alternatively, the mouse pointer 22F may travel only across the game screen 21A.

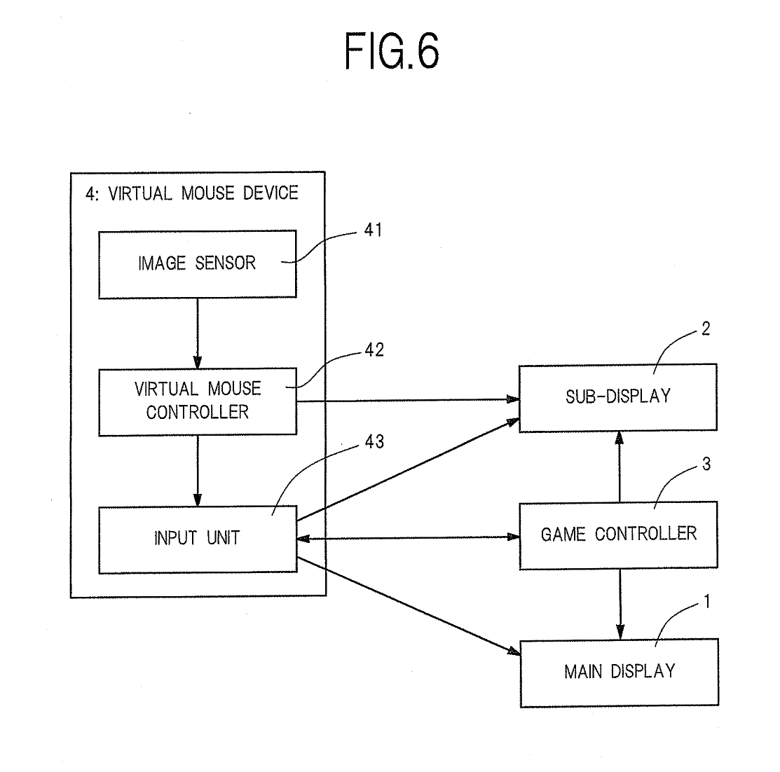

Referring to FIG. 6, the gaming machine 10 shown in FIGS. 1 and 2 has a functional configuration that includes a game controller unit 3 and a virtual mouse device 4 in addition to the main display unit 1 and the sub-display unit 2. The gaming machine 20 shown in FIGS. 4 and 5 has a similar functional configuration.

The main display unit 1 reproduces the game screen 1A shown in FIG. 2 on the basis of image data received from the game controller unit 3 or the virtual mouse device 4. Similarly, the sub-display unit 2 reproduces the input screen 2A shown in FIG. 2 on the basis of image data received from the game controller unit 3 or the virtual mouse device 4.

The game controller unit 3 is preferably comprised of a microcomputer including a CPU, a ROM, and a RAM. The game controller unit 3 is preferably installed in the body of the main display unit 1 or the sub-display unit 2 shown in FIGS. 1 and 2. Alternatively, the game controller unit 3 may be separated from the display units 1 and 2, and linked to them by wired or wireless connections. The game controller unit 3 preferably stores one or more types of game programs. Alternatively, the game controller unit 3 may download game programs from a server through wired or wireless connections. The game controller unit 3 executes a game program. Here, the game controller unit 3 may allow a player to select a desired one of the game programs in advance, by using the input screen 2A and the virtual mouse 2G. The game controller unit 3 then conducts a game according to the executed game program, and thereby controls game functions and provides appropriate image data to the display units 1 and 2. During game rounds, the game controller unit 3 receives instructions and data that the virtual mouse device 4 has accepted from a player, and then changes game status depending on the instructions or the data.

For example, the game controller unit 3 conducts a slot game as follows. A player first enters cash or monetary data into the gaming machine 10 in a well-known manner to store credits in the gaming machine 10. The game controller unit 3 causes the main display unit 1 to display the video reels 1B on the game screen 1A, and causes the sub-display unit 2 to display graphic elements 2B-2E on the input screen 2A. The player uses the mouse pointer 2F and the virtual mouse 2G to select one or more paylines and an amount of a bet to be placed on each selected payline. For example, an amount of a bet is displayed in a window 2B, and incremented or decremented at each click of an icon 2C. Each button 2E is assigned to a payline. When a button 2E is clicked, the corresponding payline will be selected. The virtual mouse device 4 monitors the relationship in location between the graphic elements 2B-2E and the mouse pointer 2F, and accepts each pair of a payline and an amount of a bet selected by the player. The game controller unit 3 receives selected pairs of a payline and an amount of a bet from the virtual mouse device 4, and then decreases the credits by the amount of the bet. In addition, the game controller unit 3 may display the amounts of the bet and the available credits and the selected paylines on the display units 1 and 2. When the player has click a button 1C to cue the video reels 1B for the start of a spin as shown in FIG. 2, the game controller unit 3 starts the spins of the video reels 1B. On the other hand, the game controller unit 3 randomly determines symbols to be displayed on the video reels 1B when it will stop them. Furthermore, the game controller unit 3 checks a winning combination of symbols in the symbols to be arranged on the stopped video reels 1B, and thereby determines whether or not to provide an award to the player. After a predetermined time has elapsed from the start of the spin, the game controller unit 3 stops the video reels 1B at the predetermined positions. If a winning combination that represents an amount of a payout is detected, the game controller unit 3 will increase the credits by the payout. In addition, the game controller unit 3 controls the display units 1 and 2 to produce visual effects to announce the winning of the payout.

The virtual mouse device 4 serves as a graphical user interface by using the mouse pointer 2F and the virtual mouse 2G. Referring to FIG. 6, the virtual mouse device 4 includes an image sensor unit 41, a virtual mouse controller unit 42, and an input unit 43.

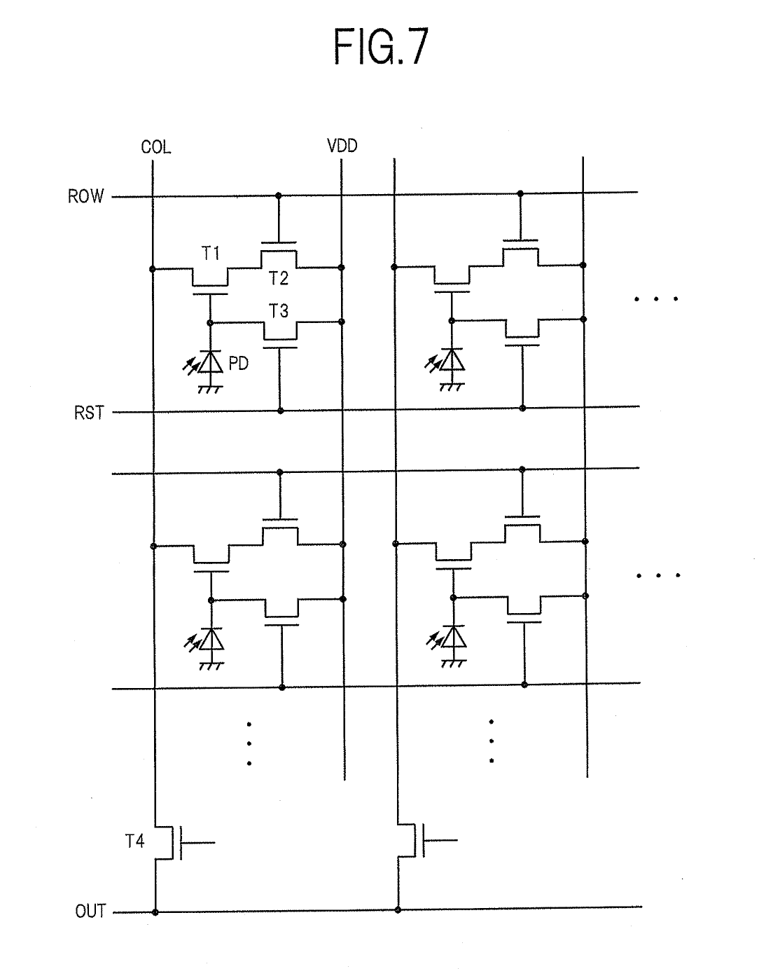

The image sensor unit 41 preferably includes an array of CMOS sensors that are arranged in a transparent film laminated on the mouse pad area 2H. Referring to FIG. 7, each CMOS sensor of the image sensor unit 41 preferably includes three FETs T1, T2, and T3, and a photodetector PD. The FETs are preferably thin film transistors (TFTs). The photodetector PD is preferably a photodiode. External light is absorbed in the photodetector PD, and then induces a voltage at the gate of a first FET T1. The level of the voltage depends on the intensity of the external light. The sources of the first FETs T1 aligned on each column of the CMOS sensors are connected to the same column line COL, which runs in the array of the CMOS sensors in the column direction. Each column line COL is connected through a fourth FET T4 to an output line OUT. The drain of the first FET T1 is connected through a second FET T2 to a power line VDD. When the second FET T2 and the fourth FET T4 are turned on, a current flows through a path from the power line VDD, the second FET T2, the first FET T1, the column line COL, the fourth FET T4, and the output line OUT. Here, the first FET T1 serves as a source follower amplifier. The amount of the current depends on the gate voltage of the first FET T1, i.e., indicates the intensity of the external light absorbed in the photodetector PD. The gates of the second FETs T2 aligned on each row of the CMOS sensors are connected to the same row line ROW, which runs in the array of the CMOS sensors in the row direction. Accordingly, each photodetector PD is individually addressable by activation of a selected pair of a row line ROW and a fourth FET T4. Thus, light absorbed in each photodetector PD is converted to a current signal flowing through the output line OUT. A third FET T3 preferably connects a photodetector PD to a power line VDD. The gates of the third FETs T3 aligned on each row of the CMOS sensors are connected to the same reset line RST, which runs in the array of the CMOS sensors in the row direction. When a reset line RST is activated, a third FET T3 connected to the reset line RST will be turned on, and a constant voltage at the power line VDD will be applied to the photodetector PD. Then, the gate voltage of the first FET T1 will return to a default level.

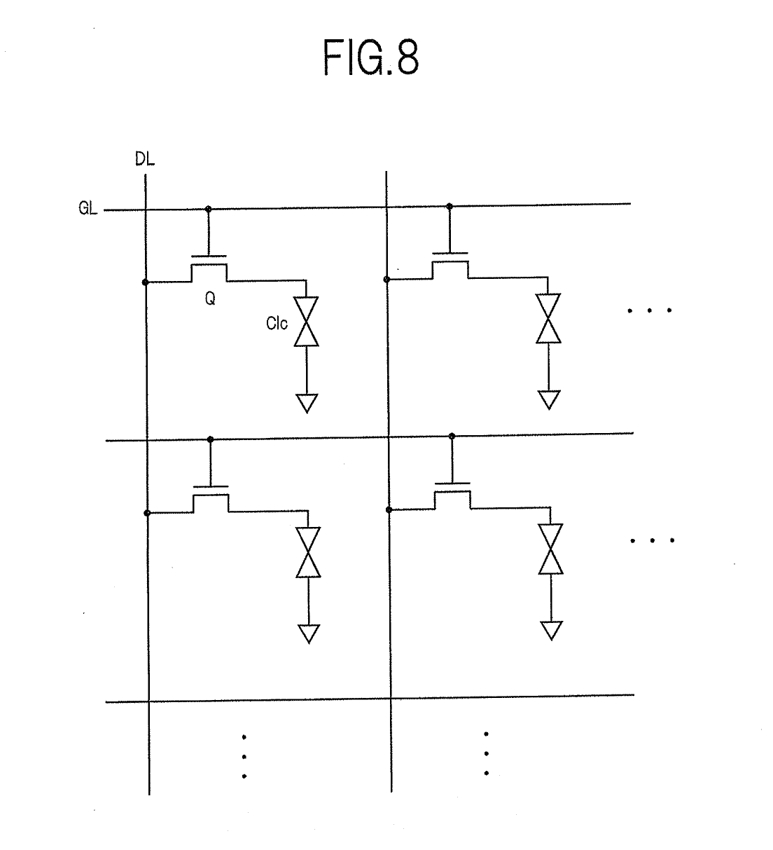

On the mouse pad area 2H in the input screen 2A as shown in FIG. 2, the image sensor unit 41, i.e., the array of the CMOS sensors is preferably laminated on an LCD panel. The LCD panel includes an array of pixels. Here, the size and shape of a pixel does not have to agree with those of the CMOS sensor. Referring to FIG. 8, each pixel typically includes a liquid crystal (LC) capacitor Clc and a TFT Q. In the LCD panel, a liquid crystal layer is sandwiched between two transparent panels (glass panels, in general). Each inner surface of the two panels is covered with electrodes. Thus, each pixel includes a portion of the liquid crystal layer sandwiched between two electrodes, which is equivalent to an LC capacitor Clc. Each LC capacitor Clc is connected through a TFT Q to a data line DL. The gates of the TFTs Q aligned on each row of the pixels are connected to the same gate line GL, which runs in the array of the pixels in the row direction. The sources of the TFTs Q aligned on each column of the pixels are connected to the same data line DL, which runs in the array of the pixels in the column direction. When a gate line is activated, TFTs Q connected to the gate line GL are turned on. Then, the LC capacitors Clc receive individual voltage pulses through the turned-on TFTs Q from respective data lines DL. At that time, the optical transmittances of the liquid crystal layers included in the LC capacitors Clc vary with the levels of the voltage pulses. Note that the level of the voltage pulse applied to each LC capacitor Clc is individually adjustable by activation of a selected pair of a gate line GL and a data line DL. Thus, the optical transmittance of each pixel is individually adjustable, and therefore a desired image can be reproduced on the array of the pixels, i.e., a screen of the LCD panel.

Preferably, the FETs T1-T4 and the photodetector PD shown in FIG. 7 are implemented in the same substrate in which the TFTs Q shown in FIG. 8 are implemented. This allows bus lines GL and DL shown in FIG. 8 to be used as bus lines ROW, COL, or RST. As a result, the image sensor unit 41 can be integrated into the input screen 2A, while maintaining an aperture ratio of each pixel at a sufficiently high level.

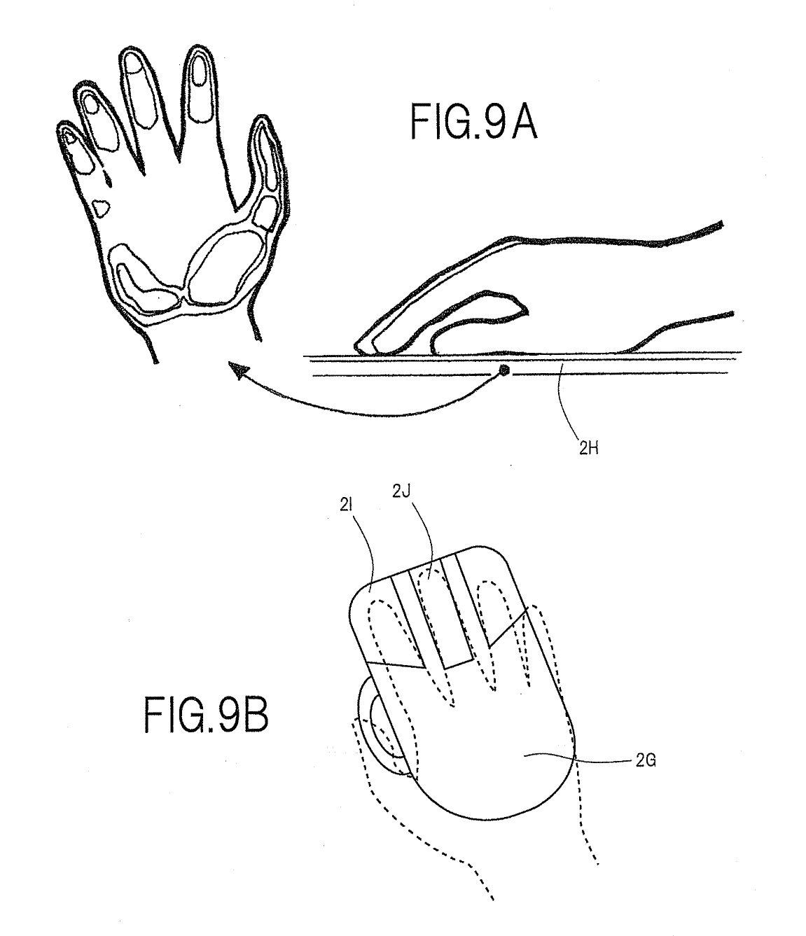

The image sensor unit 41 detects not only the presence or absence of a player's hand that touches the surface of the mouse pad area 2H, but also changes in distances of portions of the hand from the surface of the mouse pad area 2H. Referring to FIG. 9A, the image sensor unit 41 detects a distribution of intensity of light reflected from the fingers and palm of the hand. Contour lines on a hand shown in the left half of FIG. 9A join points of equal intensity of the light reflected from the hand, which has been detected by the image sensor unit 41. The intensity of the light reflected from the portions of the hand varies with distances of the portions from the surface of the mouse pad area 2H. Accordingly, the detected distribution of intensity of the reflected light indicates a size and shape of the hand as well as a location thereof. A pattern of fingerprints or veins of the hand can be also detected from the detected distribution of intensity of the reflected light. The image sensor unit 41 sends the detected distribution to the virtual mouse controller unit 42.

The virtual mouse controller unit 42 is preferably comprised of a microcomputer including a CPU, a ROM, and a RAM. The virtual mouse controller unit 42 is preferably separated from the game controller unit 3, or alternatively, may be integrated into the game controller unit 3. The virtual mouse controller unit 42 is preferably installed in the body of the sub-display unit 2 shown in FIGS. 1 and 2. Alternatively, the virtual mouse controller unit 42 may be separated from the display units 1 and 2, and linked to them by wired or wireless connections.

The virtual mouse controller unit 42 monitors fingers or a palm of player's hand that move on or over the mouse pad area 2H by using the image sensor unit 41, and causes the virtual mouse 2G to follow the fingers or the palm within the mouse pad area 2H by using the sub-display unit 2 as follows. The virtual mouse controller unit 42 first receives from the image sensor unit 41 the distribution of intensity of the light reflected from the hand, and decodes a location, size, and shape of the hand from the received distribution. Here, the virtual mouse controller unit 42 preferably stores one or more models of an average hand in advance, and determines whether or not an image decoded from the distribution of light intensity matches any model. If it matches a model, the virtual mouse controller unit 42 then recognizes the image as a hand. The virtual mouse controller unit 42 next causes the sub-display unit 2 to display the virtual mouse 2G at the decoded location of the hand. In particular, the virtual mouse controller unit 42 can adjust the position, size, and shape of the virtual mouse 2G, e.g., by scaling and deforming, on the basis of the decoded location, size, and shape of the hand, so that the virtual mouse 2G fits in the hand as shown in FIG. 9B. When the virtual mouse 2G includes a virtual button 21 and a virtual wheel 2J, preferably, the virtual button 2I and the virtual wheel 2J are positioned below the forefinger and the middle finger of the hand, respectively. Preferably, the virtual mouse controller unit 42 automatically adjusts the position, size, and shape of the virtual mouse 2G. Alternatively, the virtual mouse controller unit 42 may allow a player to manually adjust them by using the virtual mouse 2G and the input screen 2A. At each change in the detected location of the hand, the virtual mouse controller unit 42 repeats the above operations. As a result, the virtual mouse 2G follows the hand within the mouse pad area 2H. Furthermore, the virtual mouse controller unit 42 transmits information about each motion of the virtual mouse 2G to the input unit 43.

The image sensor unit 41 can detect fingers and a palm separated from the surface of the mouse pad area 2H. Accordingly, the virtual mouse controller unit 42 can determine the location of the virtual mouse 2G with a high degree of reliability when all the fingers and palm are lift from the mouse pad area 2G temporally or accidentally. This allows the virtual mouse 2G to respond to the action of the fingers and palm with a higher degree of stability than a prior art virtual mouse depending on detection of user's fingers or palm by using a touch panel.

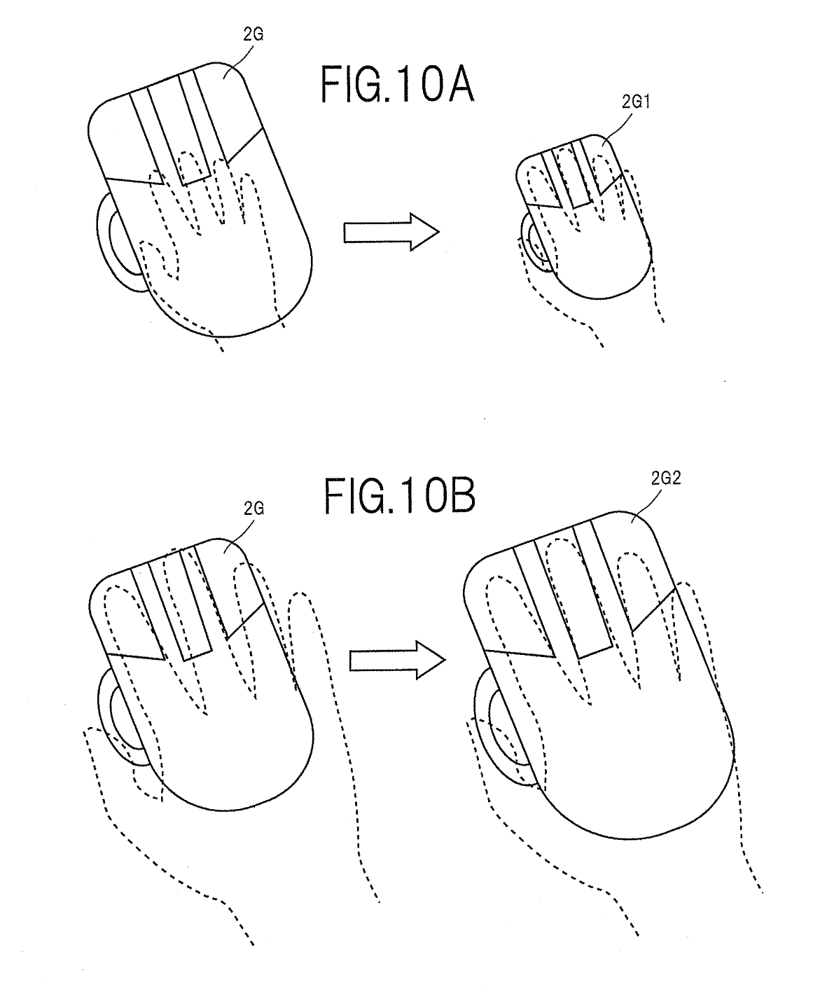

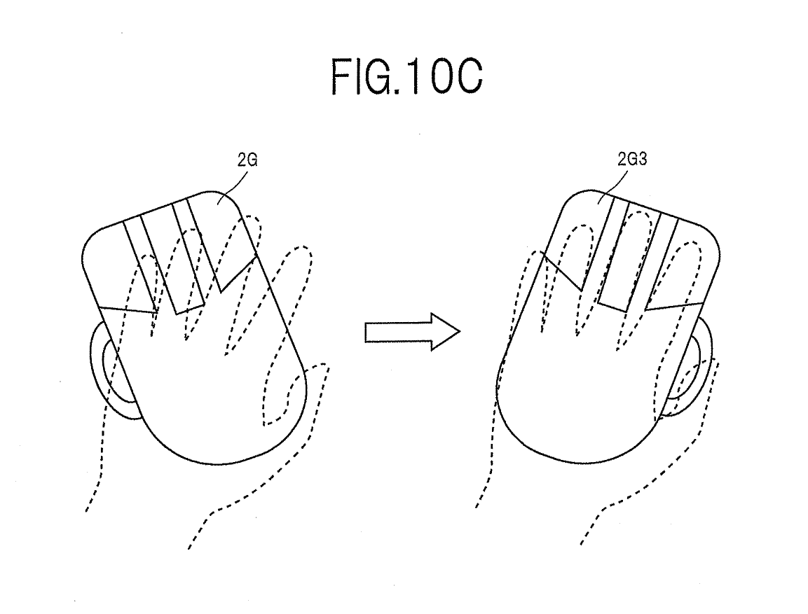

The virtual mouse controller unit 42 preferably stores one or more types of virtual mouse images, one of which is actually used as the virtual mouse 2G. Preferably, sizes, shapes, or designs vary with the types of virtual mouse images. The virtual mouse controller unit 42 selects a virtual mouse image of an appropriate type as the virtual mouse 2G on the basis of the decoded location, size, and shape of the hand. As shown in FIG. 10A, when a default size of the virtual mouse 2G is larger than the decoded size of a hand, the virtual mouse 2G1 of a smaller size will be selected. As shown in FIG. 10B, when a default size of the virtual mouse 2G is smaller than the decoded size of a hand, the virtual mouse 2G2 of a larger size will be selected. As shown in FIG. 10C, when a decoded shape of a hand is the shape of a left hand, the virtual mouse 2G3 of a left-handed shape will be selected. Note that the virtual mouse controller unit 42 may allow a player to freely select a desired type of the virtual mouse images by using the virtual mouse 2G and the input screen 2A.

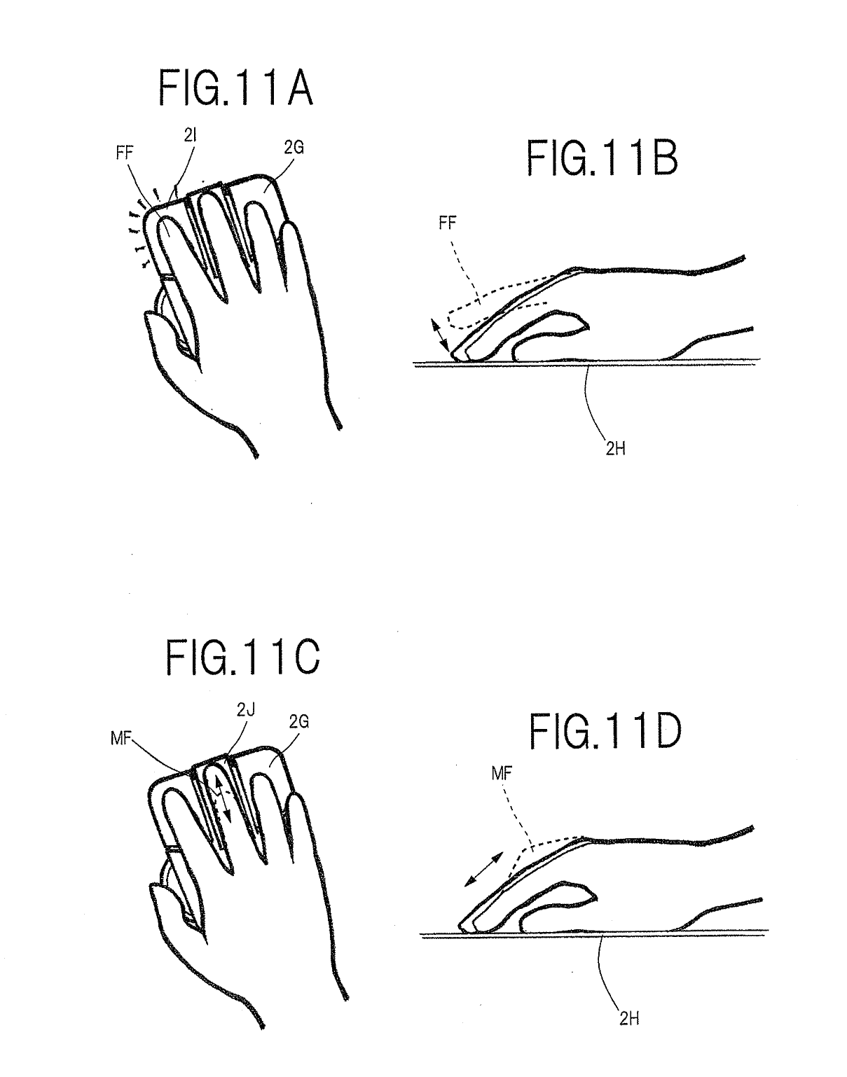

The virtual mouse controller unit 42 can detect specific movements of fingers or a palm of player's hand, i.e., specific changes in position or shape of the fingers or the palm on or over the mouse pad area 2H by using the image sensor unit 41. Referring to FIGS. 11A and 11B, a player taps his/her forefinger FF on the virtual button 21 of the virtual mouse 2G in order to click the virtual button 2I. Through the image sensor on the mouse pad area 2H, the virtual mouse controller unit 42 detects the specific changes in position of the forefinger FF caused by the tapping action. Referring to FIGS. 11C and 11D, a player slides his/her middle finger MF on the virtual wheel 2J of the virtual mouse 2G as if to roll a real mouse wheel. Through the image sensor on the mouse pad area 2H, the virtual mouse controller unit 42 detects the specific changes in position of the middle finger MF caused by the sliding action. The virtual mouse controller unit 42 informs the input unit 43 of each detection of the specific movements as an occurrence of events. In parallel, the virtual mouse controller unit 42 may change the shapes, colors, or brightness of portions of the virtual mouse 2G in such a pattern that the player can easily recognize a click of the virtual button 21 or a roll of the virtual wheel 2J.

In addition, the virtual mouse controller unit 42 may decode a pattern of fingerprints or veins of player's hand from a distribution intensity of the light reflected from the hand, which has been detected by the image sensor unit 41. The detected pattern of fingerprints or veins of the player's hand will be used in verification of the player by the virtual mouse controller unit 42 or other similar computer unit linked to the unit 42.

The input unit 43 is preferably comprised of a microcomputer including a CPU, a ROM, and a RAM. The input unit 43 is preferably integrated into the virtual mouse controller unit 42, or alternatively, may be integrated into the game controller unit 3, or separated from both the controller units 42 and 3. The input unit 43 is preferably installed in the body of the sub-display unit 2 shown in FIGS. 1 and 2. Alternatively, the input unit 43 may be separated from the display units 1 and 2, and linked to them by wired or wireless connections.

The input unit 43 preferably controls the sub-display unit 2 to display a desired design of the input screen 42 including the graphic elements 2B-2E shown in FIG. 2. The input unit 43 farther monitors the motion of the virtual mouse 2G according to the information received from the virtual mouse controller unit 42. Preferably, the input unit 43 identifies a portion of the virtual mouse 2G as a reference point, and detects the amount and direction of each travel of the reference point. The input unit 43 then causes the display units 1 and 2 to move the mouse pointer 2F on the game screen 1A and the input screen 2A depending on the amount and direction of each travel of the reference point.

On the other hand, the input unit 43 preferably receives information about graphic elements, e.g., the button 1C shown in FIG. 2, on the game screen 1A from the game controller unit 41. The input unit 43 also stores information about the graphic elements 2B-2E on the input screen 42 shown in FIG. 2. The information in particular represents relationship between the graphic elements and instructions or data to be entered into the game controller unit 3 or the virtual mouse controller unit 42. The input unit 43 decodes an instruction or data from the relationship in location between the graphic elements and the mouse pointer 2F on the game screen 1A or the input screen 2A, especially when the input unit 43 decodes a click of the virtual button 21 shown in FIGS. 11A and 11B from an event received from the virtual mouse controller unit 42. The input unit 43 then informs the game controller unit 3 or the virtual mouse controller unit 42 of the decoded instructions or data, and thereby the decoded instructions or data are entered into the controller unit 3 or 42. In particular, when the input unit 43 decodes a roll of the virtual wheel 2J shown in FIGS. 11C and 11D from an event received from the virtual mouse controller unit 42, the input unit 43 itself scrolls a portion of the input screen 2A or causes the game controller unit 3 to scroll a portion of the game screen 1A, depending on the location of the mouse pointer 2F.

The virtual mouse controller unit 42 preferably limits the mouse pad area 2H to a portion of the input screen 2A, and displays only the virtual mouse 2G overlapped with the mouse pad area 2H. Here, the boundaries of the mouse pad area may be not displayed like the mouse pad area 2H shown in FIG. 2, or may be displayed like another mouse pad area 22H shown in FIGS. 4 and 5. The explanation hereinafter will refer to elements shown in FIGS. 4 and 5 since the boundaries of the mouse pad area are clearly displayed. However, similar explanation is true for elements shown in FIGS. 1 and 2.

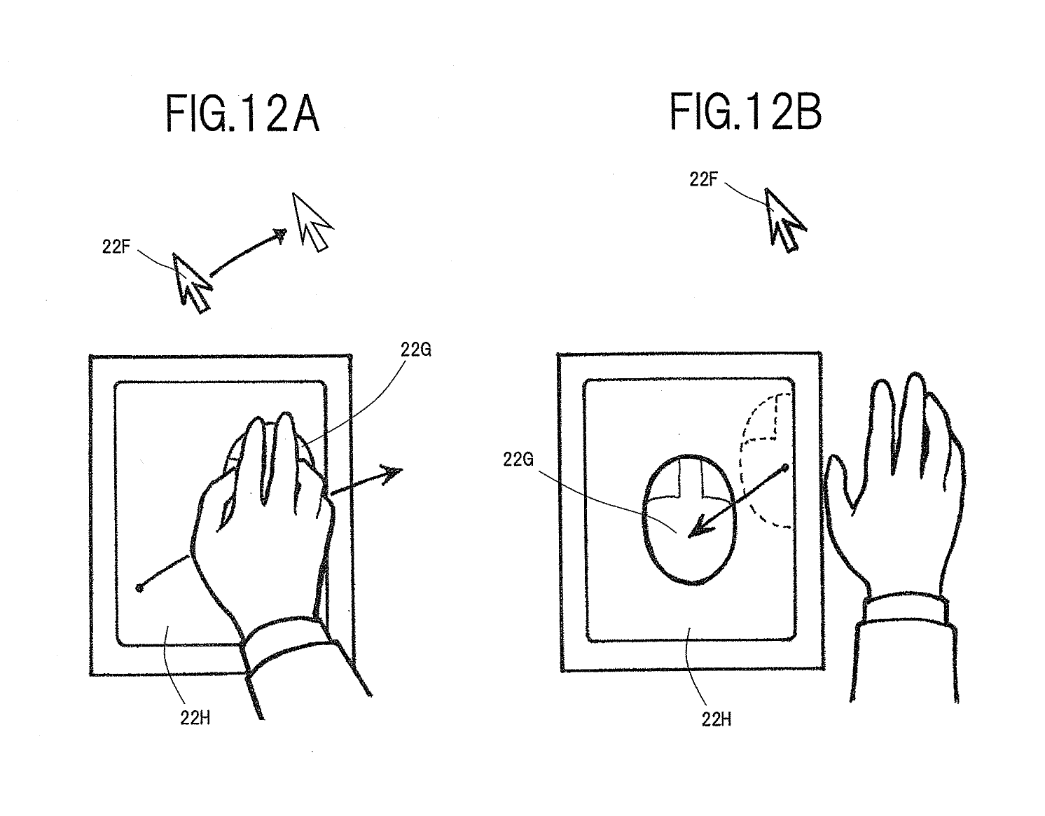

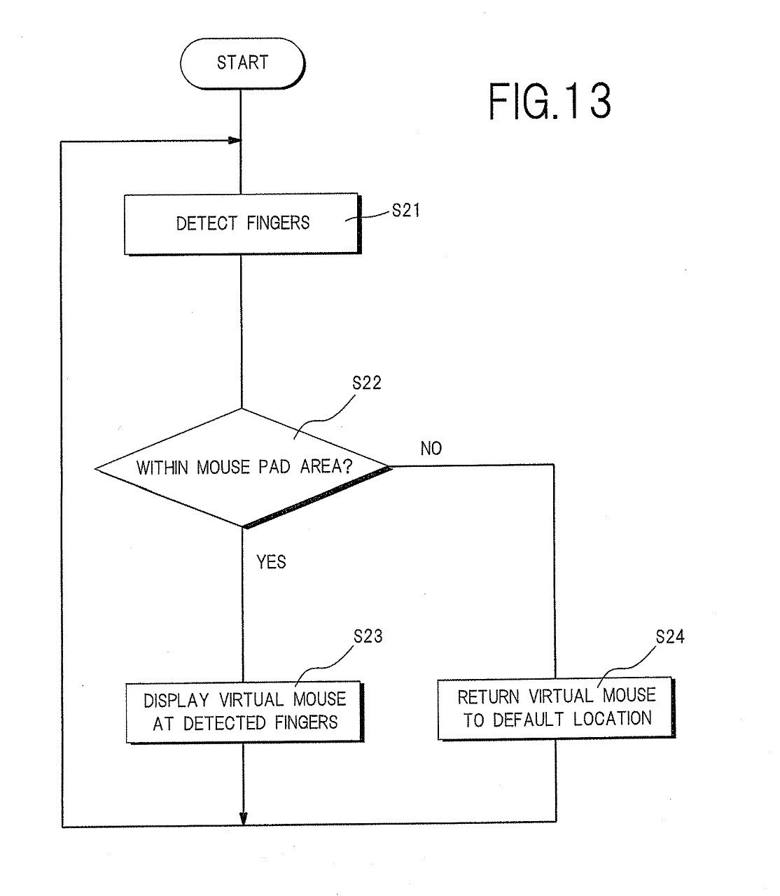

If player's fingers or palm moves out of the mouse pad area 22H across a boundary thereof as shown in FIG. 12A, the virtual mouse controller unit 42 then returns the virtual mouse 22G to a default location in the mouse pad area 22H (preferably, a center thereof) as shown in FIG. 12B. More specifically, the virtual mouse controller unit 42 controls motions of the virtual mouse 2G in the following steps S21-S24 shown in FIG. 13.

STEP S21: the virtual mouse controller unit 42 detects player's fingers or palm moving on or over the mouse pad area 22H, by using the image sensor unit 41.

STEP S22: the virtual mouse controller unit 42 determines whether or not to locate the fingers or palm within the mouse pad area 22H. Here, the virtual mouse controller unit 42 preferably determines that the fingers or palm is not located within the mouse pad area 22H in one of the following cases: when the half or more of the virtual mouse 22G is positioned in the outside of the mouse pad area 22H; when a predetermined reference portion of the virtual mouse 22G is positioned in the outside of the mouse pad area 22H; or when the image sensor 41 fails to detect any fingers and palm. If the fingers or palm has been located within the mouse pad area 22H, the process goes to the step S23, otherwise the process goes to the step S24.

STEP S23: the virtual mouse controller unit 42 causes the sub-display unit 21 to display the virtual mouse 22G at the detected location of the fingers or palm.

STEP S24: the virtual mouse controller unit 42 returns the virtual mouse 22G to a default location in the mouse pad area 22H. In this case, the virtual mouse controller unit 42 preferably informs the input unit 43 of the return of the virtual mouse 22G.

The virtual mouse controller unit 42 repeats the steps S21-S24. Limiting the mouse pad area and automatically returning of the virtual mouse from the outside to the inside of the mouse pad area facilitates control of the virtual mouse, since the virtual mouse is prevented from overlapping other graphic elements included in the input screen (cf. FIGS. 2, 4, and 5). Note that buffer strips may be arranged around the boundaries of the mouse pad area. In the buffer strips, the virtual mouse controller unit 42 inhibits the display of the virtual mouse 2G or 22G, and the input unit 43 inhibits the display of any graphic elements 2B-2E and the mouse pointer 2F.

The virtual mouse controller unit 42 preferably adjusts the size, shape, and location of the mouse pad area 2H or 22H on the basis of the detected location, size, and shape of player's hand. For example, when a larger hand has been detected on or over the mouse pad area, the virtual mouse controller unit 42 then enlarges the mouse pad area, or vice versa. In addition, when a right or left hand has been detected, the virtual mouse controller unit 42 positions the mouse pad area at the right or left portion of the input screen, respectively. Alternatively, the virtual mouse controller unit 42 may allow a player to manually adjust the size, shape, and location of the mouse pad area by using the virtual mouse and the input screen.

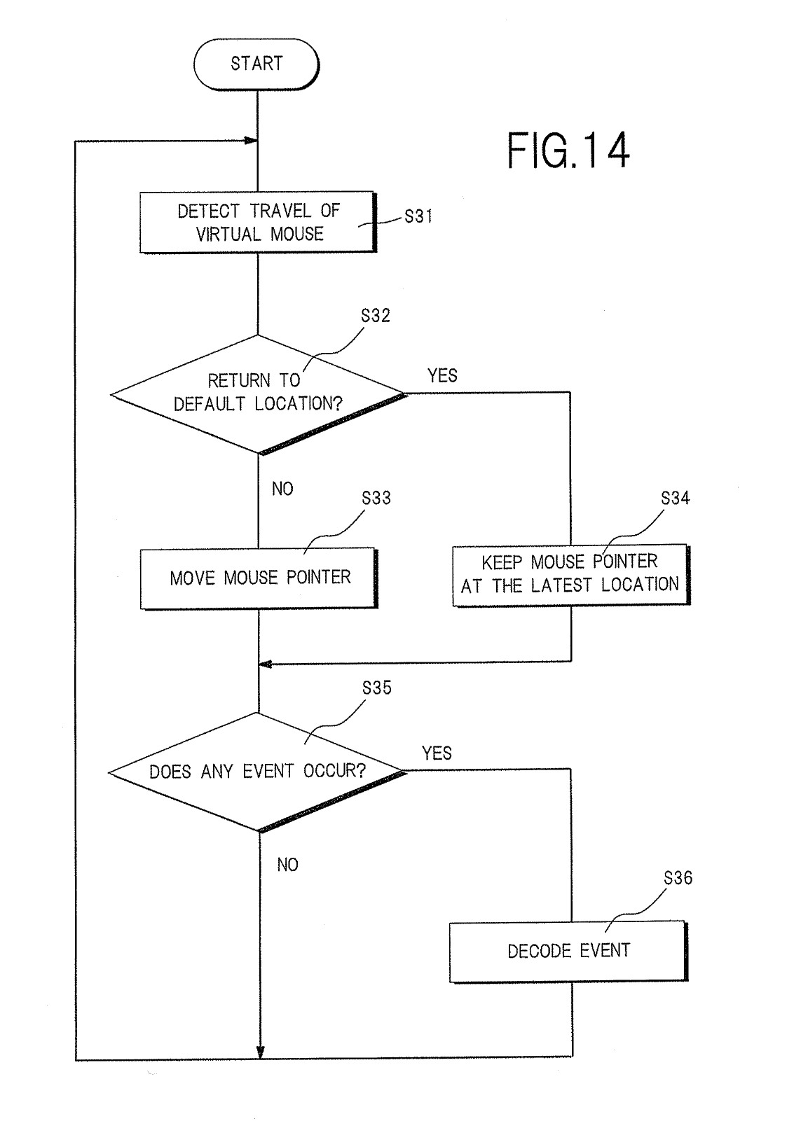

As long as the virtual mouse 22G moves within the mouse pad area 22H as shown in FIG. 12A, the input unit 43 causes the display units 21 and 22 to move the mouse pointer 22F on the game screen 21A and the input screen 22A depending on the amount and direction of each travel of the virtual mouse 22G. If player's fingers or palm moves out of the mouse pad area 22H across a boundary thereof, the input unit 43 keeps the mouse pointer 22F at the last location, regardless of the virtual mouse 22G returned to a default location as shown in FIG. 12B. More specifically, the input unit 43 controls travels of the mouse pointer 22F in the following steps S31-S36 shown in FIG. 14.

STEP S31: the input unit 43 detects the amount and direction of each travel of the reference point of the virtual mouse 22G from the information received from the virtual mouse controller unit 42.

STEP S32: the input unit 43 checks if the virtual mouse 22G is returned to a default location according to information received from the virtual mouse controller unit 42. If the virtual mouse 22G has been not returned to the default location, the process goes to the step S33, otherwise the process goes to the step S34.

STEP S33: the input unit 43 causes the display units 21 and 22 to move the mouse pointer 22F on the game screen 21A and the input screen 22A depending on the amount and direction of each travel of the reference point of the virtual mouse 22G.

STEP S34: the input unit 43 keeps the mouse pointer 22F at the last location.

STEP S35: the input unit 43 checks if any event, e.g., a click of any mouse button or a roll of a mouse wheel has been received from the virtual mouse controller unit 42. If an event has been occurred, the process goes to the step S36, otherwise the process returns to the step S31.

STEP S36: the input unit 43 decodes an instruction or data from the relationship in location between the graphic elements and the mouse pointer 22F on the game screen 21A or the input screen 22A. The input unit 43 then informs the game controller unit 3 or the virtual mouse controller unit 42 of the decoded instructions or data, and thereby the decoded instructions or data are entered into the controller unit 3 or 42.

When a player repeats the movement of his/her fingers or palm from the default location of the virtual mouse 22G to the outside of the mouse pad area 22H, the steps S31-S35 are repeated. This allows the player to operate the virtual mouse 22G in order to cause the mouse pointer 22F to travel a long distance across one or both of the game screen 21A and the input screen 22A. Thus, the virtual mouse device 4 can allow the player to easily emulate cyclical actions of a real mouse that the player slides from a location, lifts, and returns to the location in turn. In particular, the virtual mouse 22G can return to the default location more quickly than any prior art virtual mouse. Therefore, the virtual mouse device 4 can improve operability of the virtual mouse 22G.

After the image sensor unit 41 cannot detect player's finger or palm on or over the mouse pad area for a predetermined time, the virtual mouse controller unit 42 preferably erases a virtual mouse. In that case, if the image sensor unit 41 detects player's hand placed on or over a mouse pad area, the virtual mouse controller unit 42 again reproduces a virtual mouse of an appropriate size and shape below the hand in the mouse pad area as described above.

At power-on, or after the image sensor unit 41 cannot detect player's finger or palm on or over the mouse pad area for a predetermined time, the virtual mouse device 4 will execute initialization preferably in one of the following cases: when the virtual mouse device 4 has accepted an instruction to stop a game or cash all credits and the game controller unit 3 finishes changing all the credits to cash or monetary data; or when a predetermined time has elapsed after credits stored in the gaming machine has been reduced to zero while neither cash nor monetary data has been newly added. Note that the virtual mouse device 4 does not execute initialization as long as the image sensor unit 41 can detect player's finger or palm on or over the mouse pad area. Even if no credits are stored in the gaming machine, there is a possibility that a player will enter additional cash or monetary data into the gaming machine while the player stays at the gaming machine.

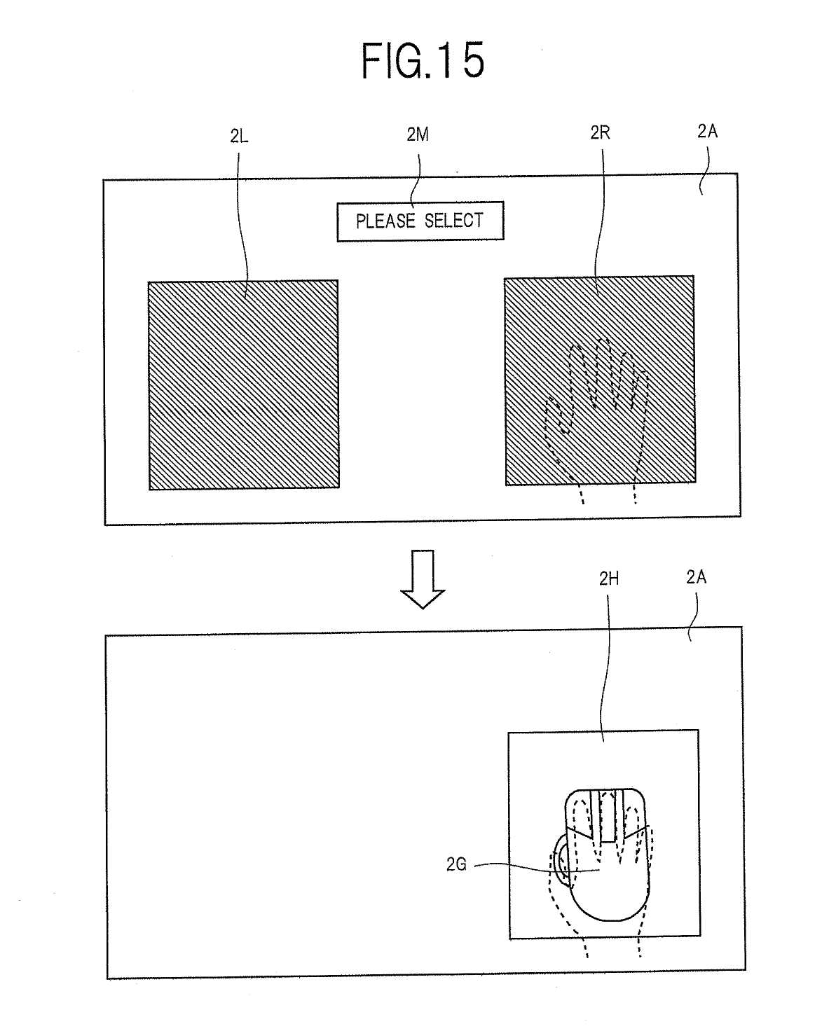

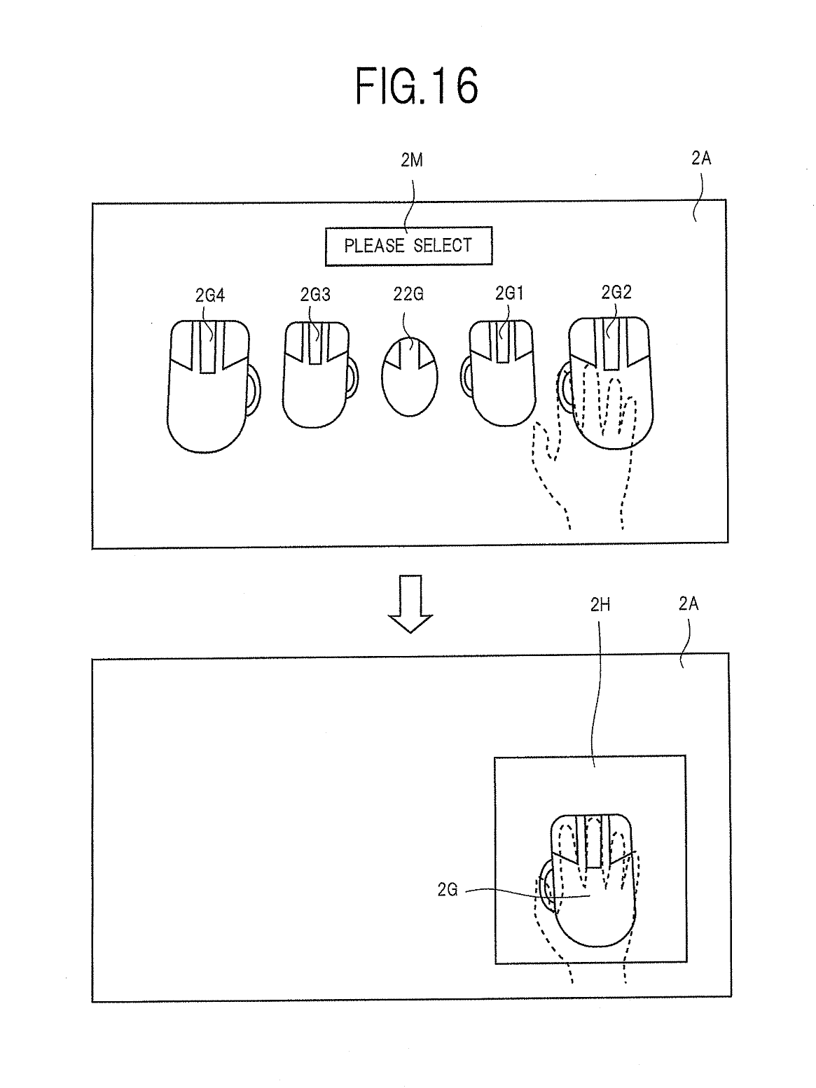

At the start of game play, the game controller unit 3 and the virtual mouse device 4 preferably display invitational screens on the game screen 1A and the input screen 2A, respectively. In particular, the virtual mouse device 4 displays either type of invitational screens shown in FIGS. 15 and 16.

Referring to FIG. 15, the virtual mouse controller unit 42 preferably causes the sub-display unit 2 to initially display two or more optional areas on the input screen 2A, one of which will be selected as the mouse pad area 2H. The optional areas preferably include areas 2L and 2R located on the left and right sides of the input screen 2A. The image sensor unit 41 includes an array of CMOS sensors shown in FIG. 7 on each optional area 2L or 2R. The game controller unit 3 or the virtual mouse controller unit 42 may further display a message 2M or the like that urges a player to select one of the optional areas 2L and 2R. When a player places his/her hand on or over a desired optional area, the image sensor unit 41 then detects the hand within the optional area. In FIG. 15, the image sensor unit 41 detects player's right hand within the right optional area 2R. Then, the virtual mouse controller unit 42 assigns the mouse pad area 2H to the right optional area 2R, and reproduces a virtual mouse 2G of appropriate size and shape below the hand. This allows the player to select a desired optional area as the mouse pad area. In this case, the virtual mouse controller unit 42 preferably adjusts the shape of the virtual mouse 2G depending on the location of a selected optional area. In the case of FIG. 15, for example, most right handed players will select the right optional area 2R, and vice versa. Accordingly, when the right or left optional area 2R or 2L has been assigned to the mouse pad area 2H, the virtual mouse controller unit 42 reproduces a right- or left-handed type of the virtual mouse 2G on the right and left optional area 2R and 2L, respectively.

Referring to FIG. 16, the virtual mouse controller unit 42 preferably causes the sub-display unit 2 to initially display one or more options of virtual mouses on the input screen 2A, one of which will be selected as the virtual mouse 2G. The options preferably vary in size, e.g., a pair of 2G1 and 2G2, and another pair of 2G3 and 2G4. The options preferably vary in shape, and in particular, the options include a mirror-image pair for left- and right-handed types, e.g., a pair of 2G1 and 2G3 and a pair of 2G2 and 2G4. In addition, the options may vary in design, e.g., 2G1 and 22G. The image sensor unit 41 includes an array of CMOS sensors on the portion of the input screen 2A and its vicinity in which each option 2G1-2G4 or 22G is reproduced. The game controller unit 3 or the virtual mouse controller unit 42 may further display a message 2M or the like that urges a player to select one of the options 2G1-2G4 and 22G. When a player places his/her hand on or over a desired option, the image sensor unit 41 then detects the hand on or over the option. In FIG. 16, the image sensor unit 41 detects player's right hand overlapping the right-handed, larger-sized option 2G2. Then, the virtual mouse controller unit 42 assigns the virtual mouse 2G to be actually used to the option 2G2, and reproduces the virtual mouse 2G of a size and shape appropriate to the detected hand on the mouse pad area 2H. Furthermore, when the player moves the detected hand on or over the mouse pad area 2H, the virtual mouse controller unit 42 positions the virtual mouse 2G below the hand. This allows the player to select a desired virtual mouse. In this case, the virtual mouse controller unit 42 preferably adjusts the location, size, or shape of the mouse pad area 2H depending on the initial location, size, or shape of the selected option. In FIG. 16, for example, the mouse pad area 2H of a larger size is positioned at a right portion of the input screen 2A since the right-handed, larger-sized option 2G2 has been assigned to the virtual mouse 2G.

At the start of game play, the virtual mouse device 4 may verify a player by using a pattern of fingerprints or veins of the player's hand that the virtual mouse controller unit 42 has been decoded from images captured by the image sensor unit 41.

The virtual mouse device 4 may cause the virtual mouse 2G or 22G to follow a barcode or a matrix code (or two-dimensional barcode) printed or displayed on a surface of an object, e.g., a card or a mobile phone, instead of player's hand.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A device comprising
a display unit configured to display one or more images on a screen;
an image sensor unit configured to detect fingers or a palm of a user that move on or over a specific area on the screen;
a virtual mouse controller unit configured to monitor the fingers or palm of the user that move on or over the specific area by using the image sensor unit, and cause a virtual mouse to follow the fingers or the palm within the specific area by using the display unit, and if the fingers or the palm moves out of the specific area, then return the virtual mouse to a default location in the specific area; and
an input unit configured to monitor the motion of the virtual mouse, and cause the display unit to move a pointer or cursor image on the screen depending on the amount and direction of travel of the virtual mouse.

2. A device according to the claim 1, wherein the input unit is configured to decode an instruction or data from the relationship in location between the images and the pointer or cursor image on the screen.

3. A device according to the claim 1, wherein the display unit and the image sensor unit are integrated into a single panel.

4. A device according to the claim 1, wherein the display unit comprises two or more separate screens, the specific area is placed on one of the screens, and the input unit is configured to cause the display unit to move the pointer or cursor image on one or more of the screens.

5. A device according to the claim 1, wherein
the virtual mouse includes a virtual button or a virtual wheel,
the virtual mouse controller unit is configured to detect specific movements of the fingers of the user by using the image sensor unit, and
the input unit is configured to decode a click of the virtual button or a roll of the virtual wheel from the specific movements of the fingers.

6. A device according to the claim 1, wherein
the virtual mouse includes a virtual button, and
the virtual mouse controller unit is configured to cause the display unit to position the virtual button below the forefinger of the user that moves on or over the specific area.

7. A device according to the claim 1, wherein the virtual mouse controller unit is configured to determine the size or shape of a hand from the fingers or palm of the user detected by the image sensor unit, and then adjust the size or shape of the virtual mouse depending on the determined size or shape of the hand.

8. A device according to the claim 7, wherein the virtual mouse controller unit is configured to adjust the size, shape, or location of the specific area on the screen depending on the determined size or shape of the hand.

9. A device according to the claim 1, wherein
the image sensor unit is configured to detect fingers or a palm of a user that move on or over one or more optional areas on the screen, and
the virtual mouse controller unit is configured to cause the display unit to initially display the optional areas on the screen, and when the image sensor unit has detected fingers or a palm of a user within one of the optional areas, the virtual mouse controller unit is configured to assign the specific area to the optional area within which the image sensor unit has detected the fingers or palm of the user.

10. A device according to the claim 9, wherein the virtual mouse controller unit is configured to adjust the shape of the virtual mouse depending on the location of the optional area to which the specific area has been assigned.

11. A device according to the claim 1, wherein the virtual mouse controller unit is configured to cause the display unit to initially display one or more options of virtual mouses on the screen, and when the image sensor unit has detected fingers or a palm of a user within an area in which one of the options is displayed, the virtual mouse controller unit is configured to assign the virtual mouse to be actually used to the option that is displayed in the area within which the image sensor unit has detected the fingers or palm of the user.

12. A device according to the claim 11, wherein the virtual mouse controller unit is configured to adjust the location, size, or shape of the specific area depending on the initial location, size, or shape of the option which the virtual mouse to be actually used has been assigned.

13. A gaming machine comprising
a first display unit configured to display a game screen;
a second display unit configured to display an input screen;
an image sensor unit configured to detect fingers or a palm of a user that move on or over a specific area of the input screen;
a virtual mouse controller unit configured to monitor the fingers or palm of the user that move on or over the specific area by using the image sensor unit, and cause a virtual mouse to follow the fingers or the palm within the specific area by using the second display unit, and if the fingers or the palm moves out of the specific area, then return the virtual mouse to a default location in the specific area;
an input unit configured to monitor the motion of the virtual mouse, and cause one or both of the first display unit and the second display unit to move a pointer or cursor image on one or both of the game screen and the input screen depending on the amount and direction of travel of the virtual mouse, and then decode an instruction or data from the relationship in location between images and the pointer or cursor image on the game screen or the input screen; and
a game controller unit configured to execute a game program, and thereby control game functions depending on the instruction or the data that the input unit has decoded.
